(19) United States
(12) Patent Application Publication
(10) Pub. No.: US 2005/0042574 A1
(43) Pub. Date: Feb. 24, 2005

(54) Bipolar implant

(76) Inventor: Sargon Lazarof, Woodland Hills, CA (US)

Correspondence Address: LEWIS, BRISBOIS, BISGAARD & SMITH LLP, 221 NORTH FIGUEROA STREET, SUITE 1200, LOS ANGELES, CA, 90012, US

(21) Appl. No.: 10/679,248

(22) Filed: Oct. 3, 2003

Related U.S. Application Data
(60) Provisional application No. 60/415,830, filed on Oct. 3, 2002.

(51) Int. Cl. A61C 8/00

(52) U.S. Cl. 433/174; 433/173

(57) ABSTRACT

The present invention relates generally to implants and processes for preparing implants such as dental prostheses. More particularly, the present invention concerns an implant having an expandable skirt and a widened upper hood for anchoring the implant within the bone of the patient.

This application is a conversion of provisional application 60/415,830, pursuant to 35 U.S.C. 111(b)(5).

### FIELD OF THE INVENTION

Dental implants of the character receivable within a bore provided in the jawbone are old in the art. Typically such implants comprise an apertured body portion which is placed within a bore drilled in the bone. The body portion is typically designed so that during a period of several months after its emplacement within the bore, bone tissue will grow into the aperture so as to secure the body portion of the implant in place within the bone bore. At some point in the treatment, an artificial tooth or other prosthetic component is secured to the body portion.

These procedures are undesirable in several respects. In the first place, the procedure is protracted and requires multiple visits to the oral surgeon. Secondly, during the extended period of time required for the bone tissue to grow into and around the implant, the patient can have an uncomfortable and unsightly cavity where the prosthetic component, such as an artificial tooth, will eventually go. Additionally, these procedures do not always provide adequate anchoring of the implant to the jawbone so that in time the implant can loosen, requiring further remedial work or an alternative procedure.

Several types of implants using mechanical locking means for securing the 2530 implant in place within the bore in the jawbone have been developed. Exemplary of such devices is the device described in U.S. Pat. No. 3,708,883 issued to Flander. Other dental implants are illustrated and described in U.S. Pat. Nos. 5,004,421, 5,087,199 and 6,142,782 issued to Lazarof. The Lazarof dental implant makes use of mechanical securement means, but unlike the Flander device, the Lazarof device includes means by which selected dental prosthetics of standard design can be threadably interconnected. In this way, angular corrections of the prosthetic, such as an artificial tooth, can readily be made.

Further, in one form, these prior Lazarof implants are positively secured within the bore in the bone by two separate but cooperating securement mechanisms. The first securement mechanism comprises self-tapping, external threads provided on the tubular body of the device which are threaded into the bone by rotating the device in a first direction. The second cooperating securement mechanism comprises a plurality of bone penetrating anchor blades formed on the skirt portion of the tubular body which are moved into a bone engagement position only after the implant has been securely threaded into the bone. The anchor blades are moved into the bone engagement configuration by rotating a threaded expander member also in a first direction. However, because the threads on the expander member are opposite to the threads on the tubular body, rotational forces exerted on the expander member continuously urge the implant in a tightening direction. In other words, as the anchor blades are urged outwardly, the implant is continuously urged into threaded engagement with the bone. This double locking approach permits the selected prosthetic component to be connected to the implant immediately.

The present invention provides even greater implant security than the prior art. When a tooth is extracted from a patient's mouth, the resulting cavity has a natural tapered shape. The cavity will be wider at the gumline proximal to the cavity opening. Prior art does not account for this natural tapered shape. In contrast to the prior art, the instant invention has an upper tapered hood as well as an expandable skirt. The stability of the implant is improved and abutment and prosthetic options are increased. This invention is called a bipolar implant.

### SUMMARY OF THE INVENTION

The present invention is an implant that compacts bone bi-directionally, resulting in an improved, more stable implant. The natural configuration of the cavity of an extracted tooth tapers and expands outwardly towards the gümline. The invention improves the stability of the implant and addresses the configuration of a natural cavity after tooth removal.

In the preferred embodiment of the invention, the implant assembly has a hood 15 that tapers outward, in the direction of the oral cavity of the patient's mouth. Adjacent to the hood, is a tapered, tubular body that includes a skirt receivable within a bore provided in the bone of a patient. Within the tubular body is a draw screw which has a head which is captured within the hollow body, and a threaded shank which is connected to the draw screw head and extends to an end of the skirt. The draw screw head engages an internal shoulder contained within the tapered hollow body to form a seal which isolates a first hollow body chamber on one side of the draw screw head from a second hollow body chamber on an opposite side thereof. An expansion nut has an inner threaded cavity into which the shank of the draw screw is threaded. Rotation of the draw screw through the inner cavity of the expansion nut causes radial movement of the skirt from a first retracted position to a second expanded position.

In an alternative embodiment of the invention the hood has a portion removed so that the resulting circumference around the hood is non-circular.

In another embodiment of the invention, the hood is adjacent to beveled coronal rings, which are attached to an upper collar.

In another embodiment of the invention, the hood is adjacent to an upper collar, said collar having a circumference that is equal to the largest circumference of the hood.

In an alternative embodiment of the invention, the abutment is permanantly integrated into the upper hex portion of the implant by machining, eliminating the need for attaching a separate abutment.

### BRIEF DESCRIPTION OF THE DRAWINGS

The accompanying drawings illustrate the invention. In such drawings:

FIG. 1 is a view of the present invention showing a tapered hood connected to a tapered tubular body, a skirt, a draw screw, an expansion nut, abutment and a prosthetic.

FIG. 2 is a longitudinal cross-sectional view of the bipolar dental implant of FIG. 1 taken along 2-2 showing the tapered hood, a tapered tubular body, abutment threads, the skirt, the draw screw including, a screw head, and the expansion nut.

FIG. 3 is a detailed view of the expansion nut fitted within the terminal end of the skirt of the bipolar dental implant of FIG. 1.

FIG. 4 is a view of an embodiment of the bipolar dental implant without the abutment and prosthesis showing three of the four bone anchor segments which form the skirt, the draw screw having been removed and showing the tapered hood.

FIG. 4A is a side elevation of an alternative embodiment of the bipolar dental implant where a portion of the hood is removed.

FIG. 5 is a top plan view of the hood of bipolar dental implant of FIG. 4 showing the hood, the coronal bevel rings, and the hex collar.

FIG. 5A is a top plan view of an alternative embodiment of the bipolar dental implant of FIG. 4A showing the upper hex collar, coronal bevel rings, and modified hood.

FIG. 6 is a rotated detail view of the skirt end of the outer skirt of the bipolar dental implant of FIG. 4 showing the gap between any two of the four bone anchor segments.

FIG. 7 is a longitudinal cross-sectional view of the bipolar dental implant of FIG. 1 taken along the line 7-7 of FIG. 4 showing the tapered upper hood including the abutment interface, a plurality of abutment threads and two hollow chambers formed within the tapered tubular body.

### DETAILED DESCRIPTION OF THE PREFERRED EMBODIMENTS

As shown in the drawings for purposes of illustration, the present invention is concerned with a dental implant. It will be understood, however, that the present invention may be applied to various types of implantable prosthetic devices, and is not limited to dental implants.

With reference to FIGS. 1-3, The implant assembly comprises a hood 1, which includes an upper hood 21 and a lower hood 19. The hood 1 extends outward, toward the direction of the upper hood 21. The tapered shape of the hood better accommodates the shape of a cavity within the bone of a patient resulting from the extraction of a tooth. The upper hood is adjacent to a series of beveled coronal rings 20 and the beveled coronal rings serve as an interface between the implant and an upper hex collar 9. Once an abutment 6 and upper hex collar 9 are engaged, relative rotation is not possible due to the hexagonal or multi-sided circumference. Abutment threads 5 are present within the center core of the hood, where an abutment 6 can be threadably received. In an alternative embodiment of the invention, the abutment may be permanently joined to the implant, depending on the preference of the dental professional.

Adjacent to the lower hood 19 is a tubular body 3. The tubular body 3 tapers outward towards the hood 1. The outside surface of the tubular body has bone engaging protrusions 24 which carve into the bone of the patient's jaw. The tubular body ends at the lower hood 19. The tubular body 3 is provided with internal threads 5 which are adapted to threadably receive an abutment 6.

Next to the tubular body 3 is a skirt portion 2 radially movable from a first 155 retracted position to a second expanded position. To move the skirt portion 2 into the second expanded position, there is provided an expander means shown in the drawings as comprising an expansion nut 4 and a draw screw 8. As shown in FIGS. 2 and 7 the tubular body 3 includes an internal shoulder 13 on which a head of a draw screw 22 rests. A threaded shank portion 7 of the draw screw 8 extends below the shoulder 13 generally to a lower end of the tubular body 3 where the expansion nut 4 is threaded onto the threaded shank 7.

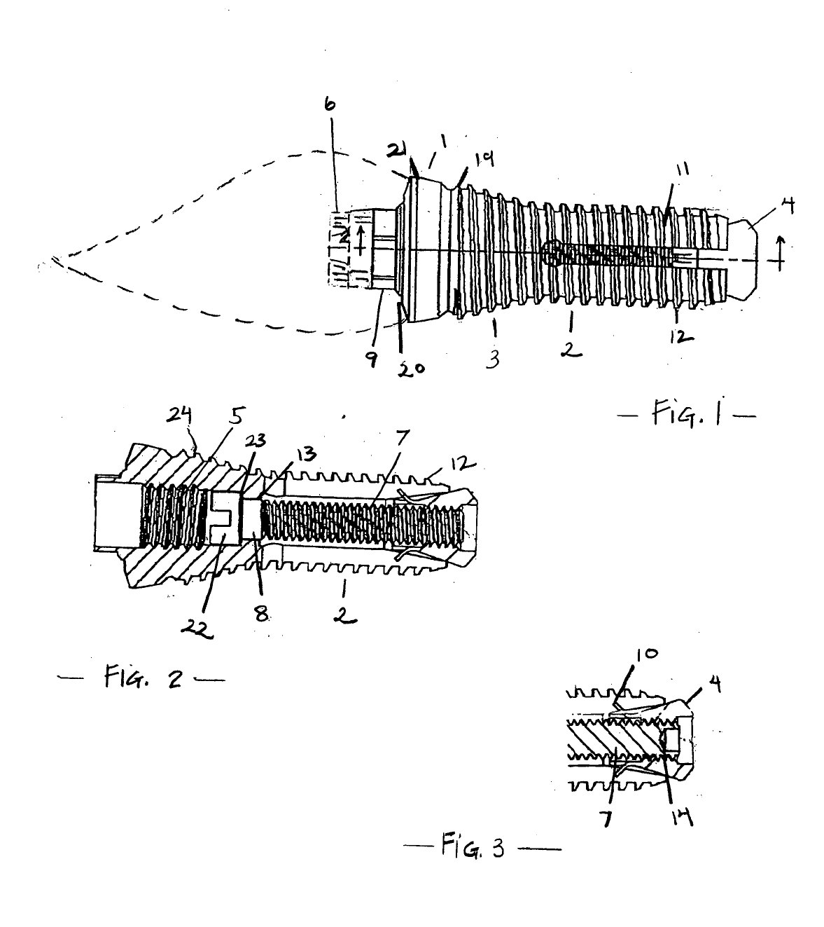

Referring to FIG. 3, the end of the threaded shank 7 includes a slot 14 that permits the end of the draw screw 8 to be enlarged after the expansion nut 4 is threaded thereon. This prevents the expansion nut 4 from being inadvertently disassociated from the draw screw 8 within the bore of the patient's jawbone.

Importantly, the draw screw 8 is configured to sealingly engage the internal shoulder 13 of the tapered tubular body 3 to isolate a first hollow body chamber 15 (defined as the area within the tubular body 3 beneath the shoulder 13 into which the threaded shank 7 extends), from a second hollow body chamber 16 (defined as the interior of the tapered hollow body 3 above the internal shoulder 13), shown in FIG. 7. In this regard, the slotted head 22 of the draw screw 8 has a tapered (non-ninety degree) shoulder 23 which, when it engages the internal shoulder 13 as the expansion nut 4 is drawn upwardly into the skirt portion 2, causes a cold weld between the facing portions of the head 22 and the shoulder 13, as best shown in FIG. 2.

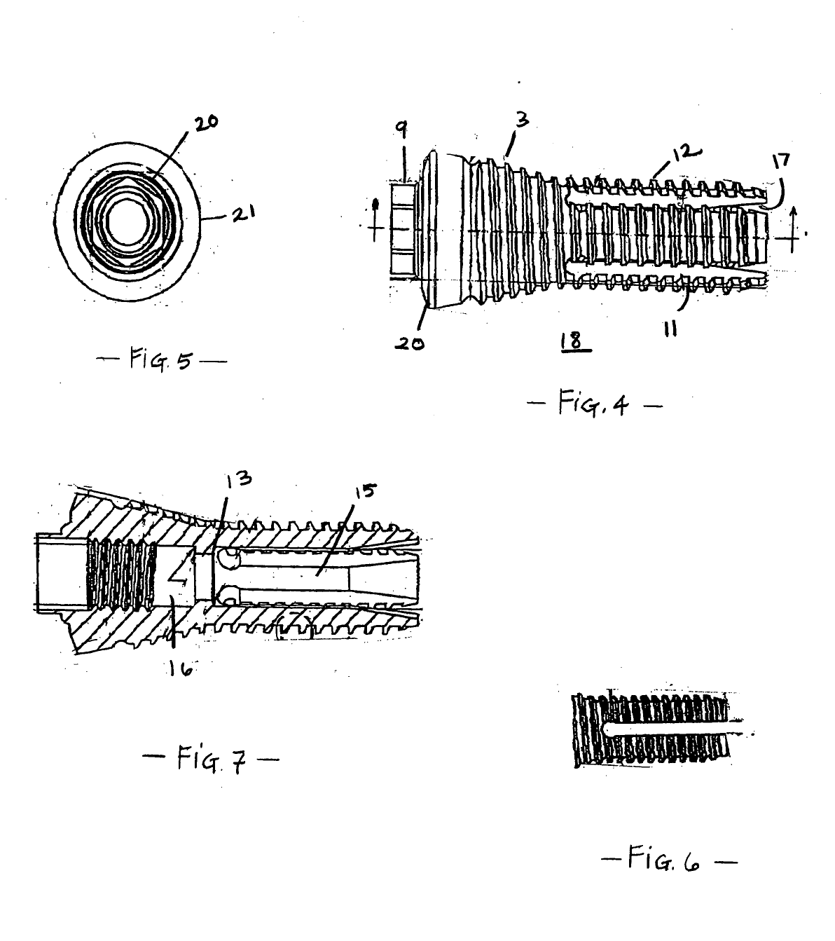

As most clearly shown in FIG. 4, the skirt portion 2 of the tubular body 3 is provided with four circumferentially spaced tapered slits 17 which define four separately-movable bone anchor segments 11 each having bone penetrating means provided in the form of a series of longitudinally spaced, blade-like bone penetrating protuberances 12. As the expansion nut 4 is drawn into the tubular body 3, the bone anchor segments 11 will be expanded outwardly so that penetrating protuberances 12 slice into the bone in a manner to securely lock the tubular body 3 within the bore of the patient. As the expansion nut 4 is being drawn into the tubular body 3, tabs 10 which extend outwardly from an upper portion of the expansion nut 4 travel upwardly through the tapered slits 17 to prevent rotation of the expansion nut 4 relative to the tubular body 3.

Prior to placing the implant assembly 18 within the jawbone of a patient, the implant assembly 18 is prepared by simply placing the draw screw 8 within the tubular body 3 so that the head 84 of the draw screw 8 rests against the internal shoulder 13. The expansion nut 4 is threaded onto the bottom end of the threaded shank 7 just enough to ensure that the tabs 10 of the expansion nut 4 will be properly aligned with the tapered slits 17. This assembly of the tubular body 3, the draw screw 8 and the expansion nut 4 is then placed within the bore. A screwdriver or allen wrench may be inserted through the upper end of the tubular body 3 to turn the draw screw 8 for the purpose of drawing the expansion nut 4 upwardly into the tubular body 3. If necessary, a wrench may be utilized to engage the upper hex 9 to prevent rotation of the tubular body 3. The tabs 10 ensure that the expansion nut 4 does not rotate relative to the tubular body 3. As the expansion nut 4 is drawn into the tubular body 3, the bone anchor segments 11 expand outwardly so that the penetrating protuberances 12 slice into the bone in a manner to securely lock the tubular body 3 within the bore of a patient's mouth.

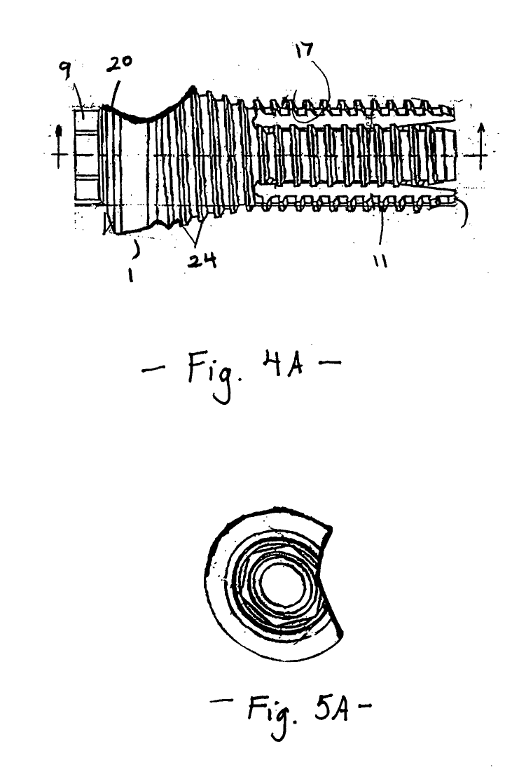

FIGS. 4A and 5A depict an alternative embodiment of the invention, where a portion of the hood is removed. The resulting hood has a circumference that is non-circular at any axial location in the hood. The purpose of this configuration, is to allow for an alternative pattern of bone growth to surround the hood 1 of the tubular body 3.

1. An implant assembly, comprising:
a hood, including an upper hood and a lower hood, with said lower hood extending outward toward the upper hood;
a hollow tubular body adjacent to said hood that includes a skirt receivable within a bore provided in a bone of a patient;
an internal shoulder contained within the tubular body where a draw screw having a head captured within the hollow body engages the internal shoulder to form a seal which isolates a first hollow body chamber on one side of the draw screw head from a second hollow body chamber on an opposite side thereof;
a threaded shank connected to the draw screw head and which extends to an end of the skirt; and
an expansion nut having an inner threaded cavity into which the shank of the draw screw is threaded, whereby rotation of the draw screw through the inner cavity of the expansion nut causes radial movement of the skirt from a first retracted position to a second expanded position.

2. The implant assembly of claim 1, where a portion of the hood is removed, resulting in a non-circular circumference at any axial location in the hood.

3. The implant assembly of claim 1, where the hood is adjacent to a set of beveled coronal rings, said rings being adjacent to an upper multi-sided collar having a smaller circumference than any of said rings.

4. The implant assembly of claim 1, where the hood is adjacent to an upper multi-sided collar having a circumference equal to the largest circumference of the hood.
